(19) United States
(12) Patent Application Publication
(10) Pub. No.: US 2010/0012628 A1
(43) Pub. Date: Jan. 21, 2010

(54) ABRASION ASSISTED WIRE ELECTRICAL DISCHARGE MACHINING PROCESS

(75) Inventors: Philip Koshy, Hamilton (CA); Ian Menzies, Peterborough (CA)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: MCMASTER UNIVERSITY, Hamilton, ON (CA)

(21) Appl. No.: 12/306,536

(22) PCT Filed: Jun. 26, 2007
(86) PCT No.: PCT/CA07/01136

§ 371 Date: Jun. 2, 2009

Related U.S. Application Data
(60) Provisional application No. 60/817,371, filed on Jun. 30, 2006.

(51) Int. Cl. B23H 1/04

(52) U.S. Cl. 219/69.15

(57) ABSTRACT

A method of wire electrical discharge machining comprising applying a pulsed voltage between a tool electrode and a workpiece which are physically separated by a working gap, the tool electrode being in the form of a wire with an electrically conductive core and an external surface embedded with an electrically non-conductive abrasive material.

### FIELD OF INVENTION

This invention relates to wire electrical discharge machining.

### BACKGROUND OF THE INVENTION

### Electrical Discharge Machining (Prior Art)

Electrical Discharge Machining (EDM) is a machining process which is widely used in the manufacture of precision components. In EDM, a pulsed voltage is applied between a tool and a workpiece which are physically separated by a small gap of the order of 10-50 μm, in the presence of a dielectric fluid. Heat generated by controlled, rapid and repetitive electrical spark discharges occurring between the tool and the workpiece is utilized to melt, vapourise and remove workpiece material.

### Wire Electrical Discharge Machining (Prior Art)

Wire EDM is a variant of the EDM process, in which the tool electrode is in the form of a flexible wire, typically about 300 μm or less in diameter, which translates along its axis. This process is well adapted for machining intricate geometries in hard materials with high precision. However, major shortcomings are:

(i) low material removal rate which renders the process rather slow and expensive, and

(ii) the presence of a crack-infested re-cast layer of work material on the machined surface due to poor material ejection efficiency which necessitates time-consuming post-EDM finishing operations such as polishing for critical high performance components to improve fatigue life, see for example U.S. Pat. No. 4,367,389 and US 2005/0102809.

A requirement to develop more environmentally friendly processing methods has seen the emergence of the dry or near-dry EDM process. This process uses a gas such as air or oxygen in the discharge gap in place of conventional oils or de-ionized water. However, use of this process is currently limited because of re-deposition of machining debris as well as low removal rates due to frequent shorting.

### Wire Saw Technology (Prior Art)

The wire saw process is widely used in the manufacture of wafers in the semiconductor industry. Initial developments in wire saw technology utilized a steel wire with the application of an abrasive slurry solution in the cutting zone. To overcome the technological limitations of this process, such as low cutting speeds and non-uniform wafer thickness due to wire wear, modern wire saw processes employ fixed abrasive wires. The wire is either fed from one spool to another and then reversed to continue the process, or used in a closed loop so as to continually feed in the same direction.

### Electrical Discharge Diamond Grinding (Prior Art)

Electrical Discharge Diamond Grinding (also known as Abrasive Electrical Discharge Grinding) is a process which integrates EDM and conventional grinding. For further information, see P. Koshy, V. K. Jain, G. K. Lal., Mechanism of material removal in electrical discharge diamond grinding, International Journal of Machine Tools and Manufacture 36 (1996) 1173-1185, and J. Kozak, K. E. Oczos, Selected problems of abrasive hybrid machining, Journal of Materials Processing Technology 109 (2001) 360-366. The role of the electrical discharges which occur at the grinding zone is to thermally soften the work material in order to facilitate grinding and to dress/declog the grinding wheel in-process for improved wheel performance.

An object of the present invention is to address the above-mentioned problems inherent to wire EDM and improve the material removal rate and provide a better surface quality.

### SUMMARY OF THE INVENTION

The present invention provides a method of wire electrical discharge machining comprising applying a pulsed voltage between a tool electrode and a workpiece which are physically separated by a working gap, the tool electrode being in the form of a wire with an electrically conductive core and an external surface embedded with an electrically non-conductive abrasive material.

In a conventional wire-EDM process, high removal rates and good surface quality are mutually exclusive, with each of these being obtained at the expense of the other. Since material removal in accordance with the present invention takes place by the combined mechanisms of melting/vapourization and abrasion, the removal rate is higher and the machined surface is of better quality because the recast material is largely removed by abrasion.

### BRIEF DESCRIPTION OF THE DRAWINGS

Embodiments of the invention will now be described by way of example with reference to the accompanying drawings of which:

FIG. 1 is a schematic view showing a typical known wire electrical discharge machining configuration;

FIG. 2 is a similar view showing a typical known configuration for wire saw slicing of wafers;

FIG. 3 is a similar view showing a typical known configuration of electrical discharge diamond grinding;

FIG. 4 is a schematic view showing abrasion assisted wire electrical discharge machining in accordance with one embodiment of the present invention;

FIG. 5 is similar to FIG. 4 but shows more detail; and

FIGS. 6(a) and 6(b) shows schematic views of locating and guiding the abrasive wire in accordance with other embodiments of the invention.

### DESCRIPTION OF PREFERRED EMBODIMENTS

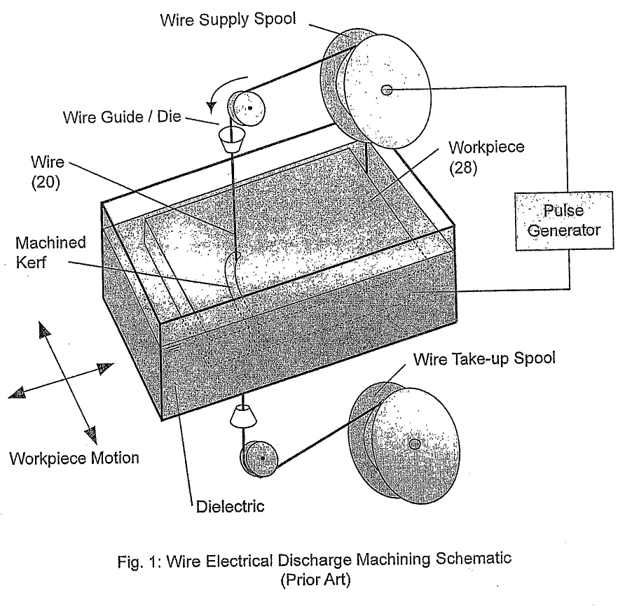

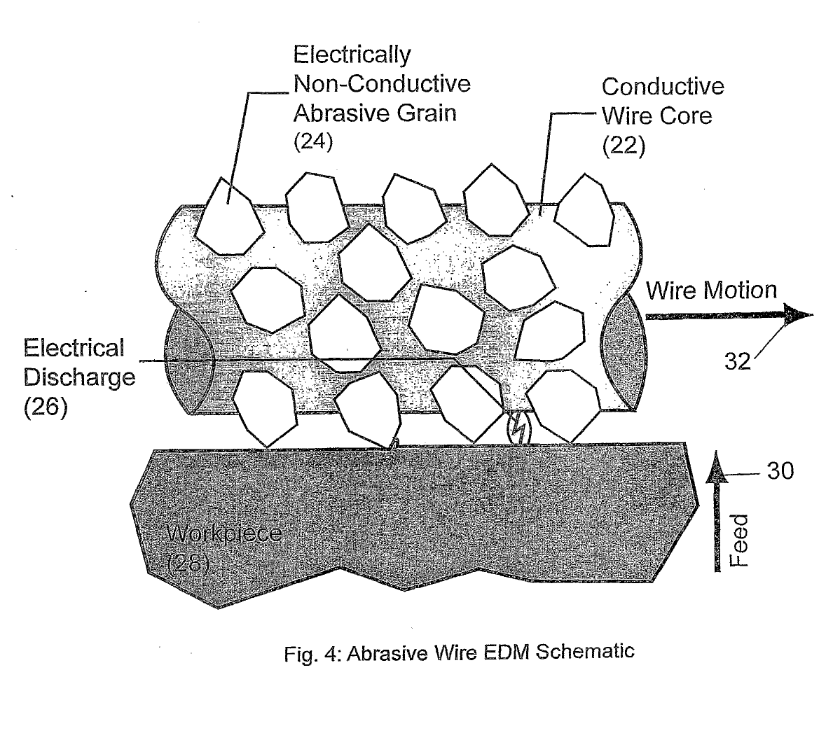

Referring to the drawings, the invention can be carried out using a conventional wire electrical discharge machining apparatus of the kind shown in FIG. 1, but modified to accept wire 20 in accordance with one embodiment of the invention which comprises an electrically conducting core 22, see FIG. 4 for clarification which is embedded with non-conductive abrasives 24.

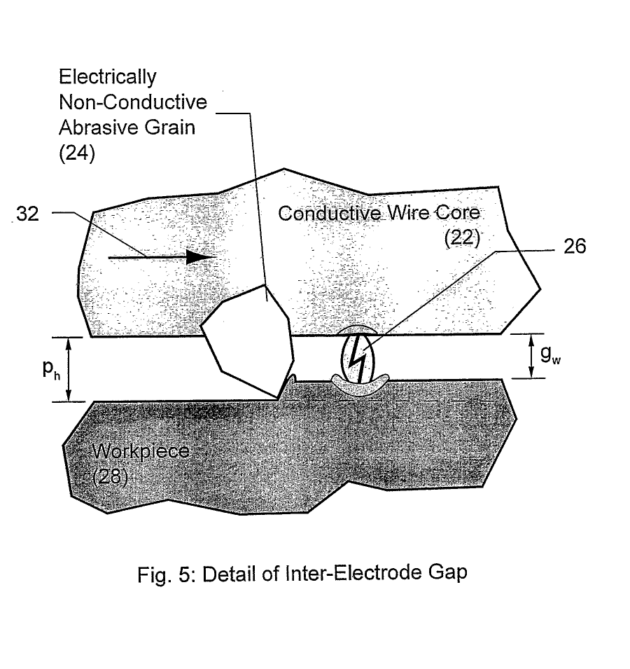

The wire 20 translates along its axis lateral to the workpiece 28, as indicated by arrow 32 in FIGS. 4 and 5. The workpiece is fed relative to the wire axis, as indicated by arrow 30 in FIG. 4, under servo control such that a gap is maintained between the workpiece and the wire core.

The gap g_{w} between the wire core 22 and the workpiece 28, see FIG. 5, may be controlled electrically and, if so, it is necessary that the wire core and the workpiece be electrically conductive. For the same reason, in order that the abrasive grain 24 and spark discharge 26 are both operative simultaneously, the abrasive has to be electrically non-conductive and have a nominal protrusion height pₕ greater than the nominal gap width g_{w}, see FIG. 5. Hence, for a given average gap width, a wire with an appropriate grit size can be chosen or alternatively, for a given wire, the gap width can be altered by changing the servo control parameters.

The EDM servo control parameters can be further adjusted with reference to feedback from the gap based on measured parameters which may include but are not limited to machining force and wire deflection. The additional feedback can be used to control the extent of material removal by mechanical abrasion for a given wire and workpiece material.

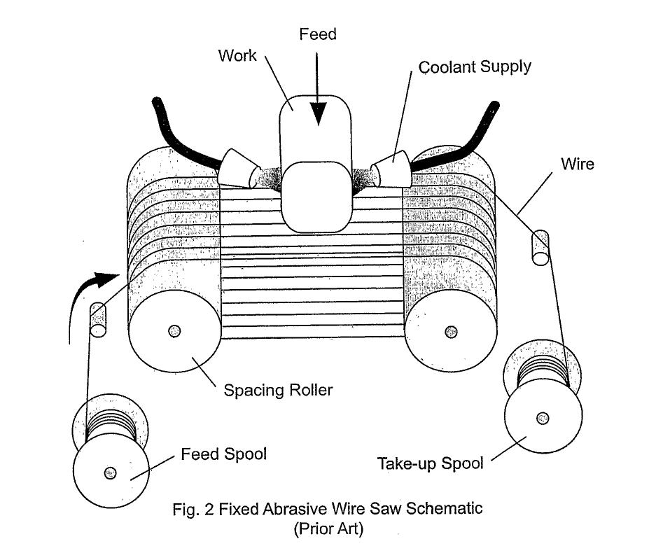

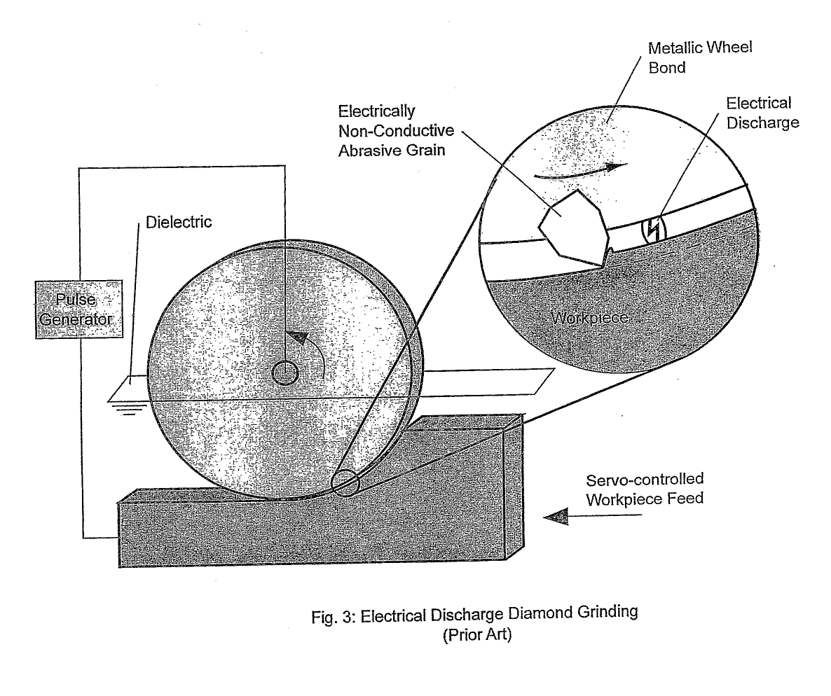

Wire implanted with electrically non-conductive abrasives, for example diamond as is typically used for wire saw cutting applications as described previously with reference to FIG. 2, may be used. However, instead of diamond, it may be desirable to employ another electrically non-conducting or semi-conducting abrasive which would serve the same purpose at a significantly lower expense. Thus, alternatives may include but are not limited to aluminum oxide, cubic boron nitride or silicon carbide.

As shown in FIG. 1, the wire 20 is positioned with respect to the workpiece 28 and guided along its axis by wire guides. It is also desirable in wire-EDM to supply the electrical power to wire through contacts which are located just above and below the confines of the workpiece so as to minimize resistive heating and inductance in the circuit.

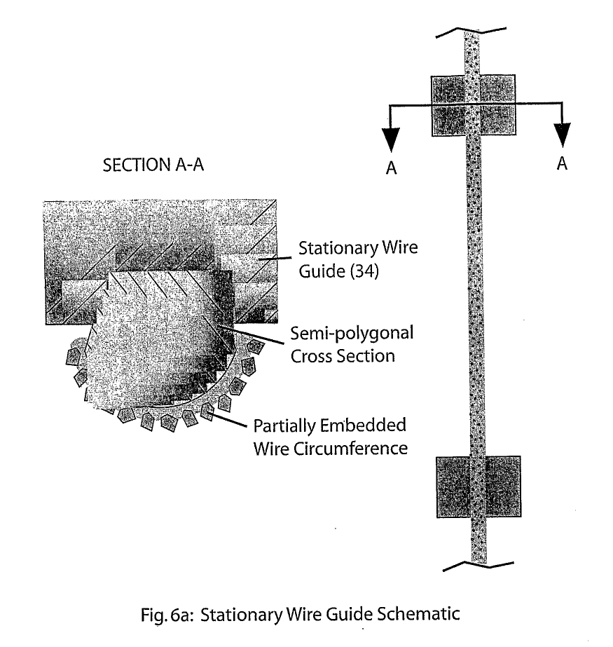

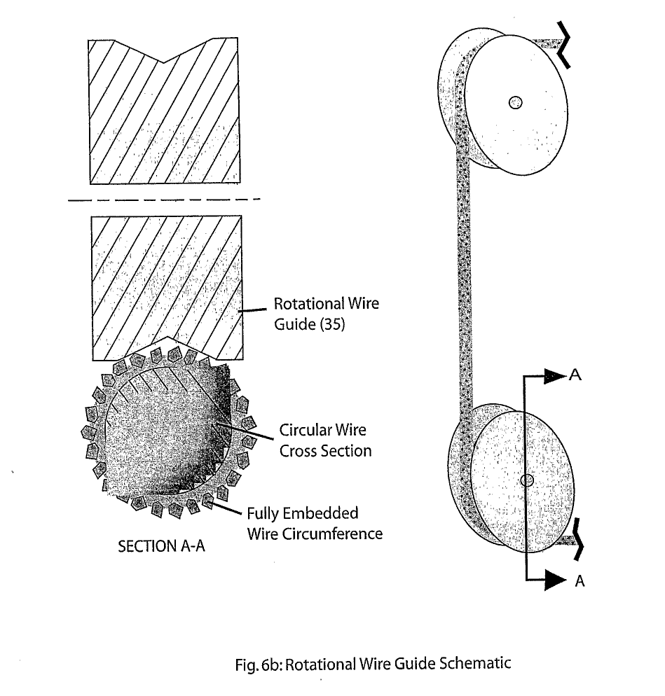

In some circumstances, the use of a wire with abrasives embedded around the entire circumference of the wire as shown in FIG. 4, may cause rapid deterioration of both the wire guides and the electrical contacts due to severe abrasion. To avoid such a problem, a wire in accordance with another embodiment of the invention has embedded abrasives only partially around the wire perimeter, as shown in FIG. 6(a). The wire cross section may be a circular, polygonal or semi-polygonal cross section, including polygons having between three and five sides, for example as shown in FIG. 6(a). The sector of the wire which is free of abrasives can thus be used to supply electrical power to the wire core without abrading the electrical contacts. The polygonal shape is utilized to locate and guide the wire along its axis with no abrasion of the wire guide 34.

The wire and the workpiece are oriented such that the machined surface, or specifically the instantaneous feed direction, is normal to the sector of the wire which is embedded with abrasives. This may be accomplished by various means, which include but are not limited to the addition of a rotary axis on the wire guides allowing them to be rotated to match the required feed direction, or the addition of a rotary axis on or below the XY work table which will enable the workpiece to be oriented such that the feed direction is normal to the abrasive wire sector or a combination thereof.

A wire with abrasives embedded around the circumference of the wire, either partially or fully as shown in FIG. 4 used in conjunction with grooved rotational guides so as to minimize relative motion between the wire and the guiding elements 35, see FIG. 6(b), as opposed to conventional stationary wire guides which could be subject to excessive wear as a result of abrasion by the wire. The application of electrical power may be accomplished by various means which include but are not limited to the use of liquid-metal coupling (including mercury and other low melting temperature metals), electrolytic coupling or conductive brushes.

In use of the invention in conjunction with existing dry or near-dry WEDM methods, the non-conducting abrasives will act to electrically isolate the workpiece and wire core. Also, the abrasive action will further remove the recast layer and any re-deposited debris.

Other embodiments of the invention will now be readily apparent to a person skilled in the art from the foregoing description, the scope of the invention being defined in the appended claims.

1. A method of wire electrical discharge machining comprising applying a pulsed voltage between a tool electrode and a workpiece which are physically separated by a working gap, the tool electrode being in the form of a wire with an electrically conductive core and an external surface embedded with an electrically non-conductive abrasive material.

2. A method according to claim 1 in which the nominal protrusion height pₕ between the wire and a distal end of the abrasives is greater than the nominal working gap width g_{w}.

3. A method according to claim 1 wherein the wire is embedded with abrasives only partially around the circumference thereof.

4. A method according to claim 3 wherein the said abrasive could be diamond, cubic boron nitride, aluminum oxide or silicon carbide.

5. A method according to claim 1 in wherein the wire is circular, polygonal or semi-polygonal in cross-section.

6. A method according to claim 4 wherein the wire is guided through rotational dies.

7. A method according to claim 4 wherein the wire is guided through stationary dies.

8. A method according to claim 1 wherein electrical contact is made through liquid coupling including metallic and electrolytic coupling, or solid coupling including brushes.

9. A method according to claim 1 wherein the gap is filled with a non-conducting gas, such as air or oxygen, and the non-conducting abrasives embedded in the wire prevent excessive shorting in a dry WEDM process as well as serve to aid in the removal of debris.
